(19) United States
(12) Patent Application Publication
(10) Pub. No.: US 2020/0073476 A1
(43) Pub. Date: Mar. 5, 2020

(54) SYSTEMS AND METHODS FOR DETERMINING DEFECTS IN VISUAL FIELD OF A USER

(71) Applicant: Samsung Electronics Co., Ltd., Suwon-si, Gyeonggi-do (KR)

(72) Inventors: Vijay Narayan TIWARI, Bangalore (IN); Joy BOSE, Bangalore (IN); Ajit S. BOPARDIKAR, Bangalore (IN); Tushar SIRCAR, Bangalore (IN); Dattanand Arun RAYKAR, Bangalore (IN); Aarshee MISHRA, Bangalore (IN); Anirban BHADURI, Bangalore (IN); Amit NANDAN, Bangalore (IN)

(21) Appl. No.: 16/493,168

(22) PCT Filed: Mar. 15, 2018
(86) PCT No.: PCT/KR2018/003058

§ 371 Date: Sep. 11, 2019

(30) Foreign Application Priority Data
Mar. 15, 2017 (IN) 201741008992
Mar. 14, 2018 (IN) 201741008992

(51) Int. Cl. G06F 3/01; G02B 27/01

(52) U.S. Cl. CPC G06F 3/015; G02B 2027/014; G02B 27/017; G06F 3/013

(57) ABSTRACT

Embodiments herein disclose systems and methods for determining defect in visual field of a user. The present disclosure relates to field of medical analysis and diagnostics and more particularly relates to systems and methods for determining neurological visual diseases of the user by using the Virtual Reality (VR) display device such as a Head Mounted Display (HMD) device. The method includes providing visual stimuli along with a center weighted object to test the neurological visual disease of the user. The method includes generating a heat map or a graph to display region of blind spot in the eye of user.

### TECHNICAL FIELD

The present disclosure relates to the field of medical analysis and diagnostics and more particularly relates to systems and methods for determining neurological visual diseases of a user by using the Virtual Reality (VR) display device such as a Head Mounted Display (HMD) device.

### BACKGROUND ART

In general, visual field defects can be early indicators of a plurality of ophthalmological and neurological diseases such as glaucoma, tumors, macular degeneration and diabetes. The diseases may need to be diagnosed in early stages to prevent irreversible vision loss. The conventional systems, such as Humphrey perimeter device, which are used to detect visual defects can be large and expensive and hence, can be accessible only at hospitals. Also, it may require a controlled testing environment such as a dim testing room along with a light control. Further, it may be inconvenient for a user to frequently visit a hospital for checking for visual field defects. Also, it may be inconvenient for the user to fixate the position of the head of the user throughout the test or diagnosis of the visual field defect in such conventional systems.

Also, the conventional head-mounted perimeters may require a physical connection to a computer or server, which may result in limited portability. Further, the conventional systems may not allow the physician to remotely verify the assessment of visual field loss in neurological diseases such as brain tumors. Also, it may not allow the user to measure neurological defects such as brain defects which may cause vision field defect. The conventional systems may also cause eye fatigue to the user due to fixation of the eye position.

### DISCLOSURE OF INVENTION

### Technical Problem

An aspect of the embodiments herein is to disclose systems and methods for determining defects in the visual field of a user using a Virtual Reality (VR) device such as Head Mounted Display (HMD) device.

Another aspect of the embodiments herein is to disclose systems and methods for determining defects in the visual field of the user due to a brain related visual defect, by using an Electroencephalography (EEG) sensor device along with the HMD device.

Another aspect of the embodiments herein is to disclose systems and methods for real-time detection of region of vision loss in an eye by allowing the physician to remotely control the HMD device.

Another aspect of the embodiments herein is to disclose an interactive diagnosis system to prevent eye fatigue of the user.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates a block diagram of a system for determining defects in the visual field of a user, according to embodiments as disclosed herein;

FIG. 2 illustrates the block diagram of processing modules for determining defects in visual field of the user, according to embodiments as disclosed herein;

FIG. 3a illustrates a graphical representation of recorded user response time via an input device, based on displayed visual stimuli on a HMD device, according to embodiments as disclosed herein;

FIG. 3b illustrates a schematic diagram of time stamp of user response time corresponding to the displayed visual stimuli, according to embodiments as disclosed herein;

FIG. 3c illustrates a graphical representation of outlier analysis for False Positive (FP) detection, according to embodiments as disclosed herein;

FIG. 4 illustrates a block diagram for learning the user behavior by using a HMD device and a EEG sensor device, according to embodiments as disclosed herein;

FIGS. 5a, 5b and 5c illustrates a schematic diagram of display of the HMD device, according to embodiments as disclosed herein;

FIG. 6a illustrates a graph diagram for detected blind spot, according to embodiments as disclosed herein;

FIG. 6b illustrates a heat map diagram for detecting reliability parameter such as fixation loss, according to embodiments as disclosed herein;

FIGS. 7a and 7b illustrates a graph diagram for response time provided by the user based on a visualized visual stimuli, according to embodiments as disclosed herein;

FIG. 7c illustrates a heat map diagram for the response time provided by the user based on the visualized visual stimuli, according to embodiments as disclosed herein;

FIG. 8 illustrates a schematic diagram of a center weighted object displayed on the HMD device, according to embodiments as disclosed herein;

FIG. 9 illustrates a schematic diagram of a method for controlling the HMD device by a physician, according to embodiments as disclosed herein;

FIG. 10 illustrates a graph diagram for indicating reliability parameters such as a false positive and a false negative data based on the response provided by the user, according to embodiments as disclosed herein;

FIG. 11 illustrates a schematic diagram of overall system flow for determining the defects in visual field of the user, according to embodiments as disclosed herein;

FIG. 12a is a flow chart of method for checking for at least one defect in visual field of the user, according to embodiments as disclosed herein; and

FIG. 12b is a flow chart of method for checking for at least one defect in visual field of the user, due to brain related visual defect of the user by using EEG sensor device, according to embodiments as disclosed herein.

### BEST MODE FOR CARRYING OUT THE INVENTION

Accordingly, the embodiments herein provide a method for checking for at least one defect in visual field of a user. The method includes generating, by a Head Mounted Display (HMD) device, at least one of a first visual stimuli. Further, the method includes, displaying, by the HMD device, randomly, at least one of the generated first visual stimuli in at least one of a region of the display of the HMD device, circumferentially around a center weighted object, wherein the center weighted object is displayed on the display of the HMD device for fixating an eye gaze of a user. Furthermore, the method includes receiving, by the HMD device, a response from the user via an input device, corresponding to the displayed at least one of the first visual stimuli. Also, the method includes providing, by the HMD device, at least one of a second visual stimuli on an identified region of the display of the HMD device to find fixation loss based on at least one of response and no response provided by the user via the input device, corresponding to the displayed at least one of the first visual stimuli, wherein the at least one of the second visual stimuli is displayed with at least one of an intensity value. Further, the method includes storing, by the HMD device, the response provided by the user corresponding to at least one of the first visual stimuli and at least one of the second visual stimuli, visualized by the user. Furthermore, the method includes transmitting, by the HMD device, to an electronic device, stored data associated with a sequence of responses received via the input device, corresponding to the at least one of the first visual stimuli and at least one of the second visual stimuli. Also, the method includes receiving, by the electronic device, from the HMD device, stored data associated with the sequence of responses received via the input device, corresponding to the at least one of the first visual stimuli and at least one of the second visual stimuli. Further, the method includes identifying, by the electronic device, the responses provided by the user corresponding to each region of the display of the HMD device, based on the received stored data associated with the sequence of responses provided by the user. Furthermore, the method includes analyzing by the electronic device, the identified responses provided by the user corresponding to each region of the display of the HMD device. Also, the method includes, generating, by the electronic device, a report of a visual field measurements based on the analyzed data associated with the sequence of responses provided by the user corresponding to each region of the display of the HMD device, wherein the generated report comprises at least one of the responses and no responses provided by the user.

Accordingly, the embodiments herein provide a system for checking for at least one defect in visual field of a user comprising a head mounted display (HMD) device communicatively coupled to at least one of an electronic device and an input device, wherein the HMD device is configured to generate at least one of a first visual stimuli. Further, the HMD device is configured to display, randomly, at least one of the generated first visual stimuli in at least one of a region of the display of the HMD device, circumferentially around a center weighted object, wherein the center weighted object is displayed on the display of the HMD device for fixating an eye gaze of a user. Furthermore, the HMD device is configured to receive, a response from the user via an input device, corresponding to the displayed at least one of the first visual stimuli. Also, the HMD device is configured to provide at least one of a second visual stimuli on an identified region of the display of the HMD device to find fixation loss based on at least one of response and no response provided by the user via the input device, corresponding to the displayed at least one of the first visual stimuli, wherein the at least one of the second visual stimuli is displayed with a varied intensity. Further, the HMD device is configured to store the response provided by the user corresponding to at least one of the first visual stimuli and at least one of the second visual stimuli, visualized by the user. Furthermore, the HMD device is configured to transmit to an electronic device, stored data associated with a sequence of responses received via the input device, corresponding to the at least one of the first visual stimuli and at least one of the second visual stimuli. The input device communicatively coupled to the HMD device configured to receive response from the user corresponding to at least one of the first visual stimuli and at least one of the second visual stimuli, displayed on the display of the HMD device. Further, the input device communicatively coupled to the HMD device configured to transmit the received response from the user corresponding to at least one of the first visual stimuli and at least one of the second visual stimuli, to the HMD device. The electronic device communicatively coupled to the HMD device configured to receive, from the HMD device, stored data associated with the sequence of responses received via the input device, corresponding to the at least one of the first visual stimuli and at least one of the second visual stimuli. Further, the electronic device communicatively coupled to the HMD device configured to identify, the responses provided by the user corresponding to each region of the display of the HMD device, based on the received stored data associated with the sequence of responses provided by the user. Furthermore, the electronic device communicatively coupled to the HMD device configured to analyze the identified responses provided by the user corresponding to each region of the display of the HMD device. Also, the electronic device communicatively coupled to the HMD device configured to generate, a report of a visual field measurements based on the analyzed data associated with the sequence of responses provided by the user corresponding to each region of the display of the HMD device, wherein the generated report comprises at least one of the responses and no responses provided by the user.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### Mode for the Invention

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

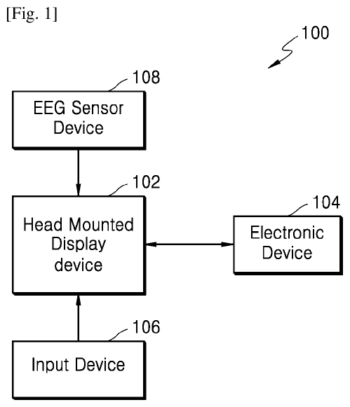

The embodiments herein achieve systems and methods for determining defects in the visual field of a user by using a Virtual Reality (VR) device such as a Head Mounted Display (HMD) device. Referring now to the drawings, and more particularly to FIGS. 1 through 12b, where similar reference characters denote corresponding features consistently throughout the figures, there are shown example embodiments.

FIG. 1 illustrates a block diagram of a system 100 for determining defects in the visual field of the user, according to embodiments as disclosed herein.

The system 100 includes a Head Mounted Display (HMD) device 102, an electronic device 104, an input device 106 and an Electroencephalography (EEG) sensor device 108. Each of the devices 102-108 in the system 100 may be connected to each other via at least one communication network (not shown). The communication network may be a wired (such as a local area network, Ethernet, fiber-optic, cable and so on) or a wireless communication network (such as Bluetooth, Zigbee, Wi-Fi, infrared, and so on). The system 100 may further include a server (not shown) and a database (not shown). In an embodiment, the system 100 may be a cloud computing platform/system. The cloud computing system, such as system 100 can be part of a public cloud or a private cloud. Although not shown, some or all of the devices in the system 100 can be connected to a cloud computing platform via a gateway. Also, the cloud platform can be connected to device located in different geographical locations.

Further, the electronic device 104 can be, but not limited, to a mobile phone, a smart phone, a tablet, a handheld device, a phablet, a laptop, a computer, a wearable computing device, a vehicle infotainment system, an IoT device, and so on. The electronic device 104 may include a processor, a memory, a storage unit, input output unit and a display unit. Further, the electronic device 104 may comprise a processing module (not shown here). When machine readable instructions are executed; the processing module causes the electronic device 104 to acquire real-time data associated with devices commissioned in the system 100 environment. The real-time data comprises an input provided by at least one of the user and a physician.

Examples of the input device 106 can be at least one of, but not limited to, a VR controller, a smart watch, a remote, a switch, a mobile, a smart phone, and so on. The input device 106 can also be attached to the HMD device 102. The user may provide the response via the input device 106, based on objects displayed on a display of the HMD device 102.

In an embodiment, a neurological visual disease such as glaucoma can be determined by the system 100. Further, the physician may also provide real-time input to remotely verify the assessment of visual field loss in neurological diseases such as brain tumors. The physician may use at least one of the electronic device 104 and the input device 106 for providing the input, which can be remotely connected with the HMD device 102.In another embodiment, brain related visual diseases can be detected by using the EEG sensor device 108.The system 100including visual perimetry utilizing VR may provide distinct brain signals coupled with perimetry test results to arrive at an objective diagnosis of brain disorders. The system 100 may also distinguish between brain related visual perimetry defects and eye related visual perimetry defects.

A plurality of multimodal indicators such as audio, video and so on can be provided in the HMD device 102.The system 100 may indicate a data related to areas\regions of vision loss. The system 100 may also dynamically determine false positives (FP) and false negatives (FN) based on the user response via input device 106. The HMD device 102 may direct the user to restart the test based on the determined user response time. The system 100 may also detect onset and progression of possible defect in visual field of the user, based on computing the difference with past test results stored in electronic device 104.

The system 100can include visual perimetry utilizing VR may provide distinct brain signals coupled with perimetry test results to arrive at an objective diagnosis of brain disorders. The system 100 may be configured to distinguish between a brain related visual perimetry defects and an eye related visual perimetry defects.

At least one of the HMD device 102 and the electronic device 104 may display the options to the user/physician to select a required type of visual perimetry test. The user/physician may select the intended type of visual perimetry test based on the requirement of the user or based on the advice provided by the physician.

Further, based on the type of the selected visual perimetry test, the HMD device 102 may select and display one or more patterns of visual stimuli. The HMD device 102 may also display a center weighted object on the display. The center weighted object can be, but not limited to, a spot, an avatar, an emoji, an image, an animation, a video and so on. The visual stimuli may be displayed around the center weighted object. Also, the visual stimuli can be displayed in each region of display of the HMD device 102.

In an embodiment, the HMD device 102 may be configured to detect fixation of an eye gaze of a user on the center weighted object displayed on the display of the HMD device 102. In another embodiment, the HMD device 102 may be configured to generate at least one of a first visual stimuli circumferentially around the center weighted object based on the detected fixation of the eye gaze on the center weighted object. In yet another embodiment, HMD device 102 may be configured to display at least one of the first visual stimuli in at least one of a region of the display of the HMD device 102, based on the detected fixation of the eye gaze on the center weighted object. Further, in yet another embodiment, the HMD device 102 be configured to receive response from the user via the input device 106, corresponding to the displayed at least one of the first visual stimuli, wherein the response from the user is received via the input device 106, if at least one of the first visual stimuli is visualized by the user. Furthermore, in yet another embodiment, the HMD device 102 may be configured to vary intensity of at least one of the first visual stimuli based on the response received from the user via the input device 106, corresponding to the displayed at least one of the first visual stimuli in at least one of the region of the display of the HMD device 102, wherein the intensity of at least one of the first visual stimuli can be varied by step size. In yet another embodiment, the HMD device 102 may be configured to store a threshold value of at least one of the first visual stimuli, visualized by the user based on varying the intensity of at least one of the first visual stimuli in at least one of the region of the display of the HMD device 102. Also, in yet another embodiment, the HMD device 102 may be configured to determine whether the eye gaze of the user is on at least one of the center weighted object and a region of the display of the HMD device 102. In yet another embodiment, the HMD device 102 may be configured to modify the position of the center weighted object with respect to the identified region of the display of the HMD device 102, based on the varying eye gaze of the user. In yet another embodiment, the HMD device 102 may be configured to provide at least one of a second visual stimuli on the region of the display of the HMD device 102 to find fixation loss based on at least one of response and no response provided by the user via the input device 106 corresponding to the displayed at least one of the first visual stimuli. Further, in yet another embodiment, the HMD device 102 may be configured to transmit, to the electronic device 104, data associated with a sequence of response received via the input device 106, corresponding to the at least one of the first visual stimuli and at least one of the second visual stimuli.

In an embodiment, the input device 106 may be configured to receive response from the user corresponding to at least one of the first visual stimuli and at least one of the second visual stimuli, displayed on the display of the HMD device 102. In another embodiment, the input device 106 may be configured to transmit the received response from the user corresponding to at least one of the first visual stimuli and at least one of the second visual stimuli, to the HMD device 102.

In an embodiment, the electronic device 104 may be configured to transmit data to the HMD device 102, wherein the HMD device 102 can used the data for generating at least one of the first visual stimuli based on a type of test pattern pre-selected by the user. In another embodiment, the electronic device 104 may be configured to receive from the HMD device 102, a data associated with the sequence of response received via the input device 106, corresponding to the at least one of the first visual stimuli and at least one of the second visual stimuli. In yet another embodiment, the electronic device 104 may be configured to generate at least one of a heat-map and a graph, of a visual field measurements based on the received data associated with the sequence of response corresponding to the at least one of the first visual stimuli and at least one of the second visual stimuli, wherein the heat-map of a visual field measurements is based on at least one of a ratio of at least one of the first visual stimuli and at least one of the second visual stimuli visualized by the user, and the learned intensity threshold associated with the region of the display of the HMD device 102.

The Electroencephalography (EEG) sensor device 108 can be communicatively coupled to the HMD device 102 and can be configured to detect signal corresponding to a brain wave associated with the user. In an embodiment, the EEG sensor device 108 may be configured to transmit, to the HMD device 102, the detected signal corresponding to the brain wave associated with the user

The electronic device 104 is communicatively coupled to the HMD device 102and can be configured to receive from the HMD device 102, the detected signal corresponding to the brain wave associated with the user. In an embodiment, the electronic device 104 may be configured to analyze the type of received signal detected by the EEG sensor device 108, by comparing the detected signal data with a table stored in the memory of the electronic device 104. In an embodiment, the electronic device 104 may be configured to obtain, the user response via the input device 106, corresponding to the displayed at least one of the first visual stimuli and at least one of the second visual stimuli. In an embodiment, the electronic device 104 may be configured to provide a brain defect data of the user, if the EEG signal is received and no user response is received via the input device 106, corresponding to the at least one of the first visual stimuli and at least one of the second visual stimuli. In another embodiment, the electronic device 104 may be configured to provide the data related to probable visual defects present in the user, if there is no EEG signal is received and no user response is received via the input device 106, corresponding to the at least one of the first visual stimuli and at least one of the second visual stimuli. In yet another embodiment, the electronic device 104 may be configured to generate at least one of the heat map and the graph based on the data received from the at least one of the HMD device 102 and the EEG sensor device 108.

Further, the at least one of the first stimulus and the at least one of the second stimulus is displayed for two hundred (200) milliseconds and the time interval between the two of at least one of the first visual stimuli is (1100-2000) milliseconds. In an embodiment, the type of test pattern pre-selected by the user comprises at least one of supra-threshold perimetry and full threshold perimetry. In another embodiment, the generating at least one of the heat-map and the graph comprises data corresponding to at least one of a response time of the user, a false positive data, a false negative data and a fixation loss data. In an embodiment herein, the false positive comprises analyzing time interval between the responses of the user by using double mean absolute deviation (DMAD) method. In an embodiment, the false positive comprises detecting response time of the user in different region of the display of the HMD device 102 based on at least one of, time of the generation of at least one of the first visual stimuli and second visual stimuli, and the time of response provide by the user via input device 106.

The center weighted object can be changed periodically to avoid eye fatigue. The user may be provided with interactive tests to ensure the user engagement in the test. The visual stimuli may vary periodically with shape, color, size, luminance, angle, and multimodal inputs (such as sound, voice, music, haptic).Further, to avoid eye fatigue the user may be provided with breaks after every 30 seconds in between the test.

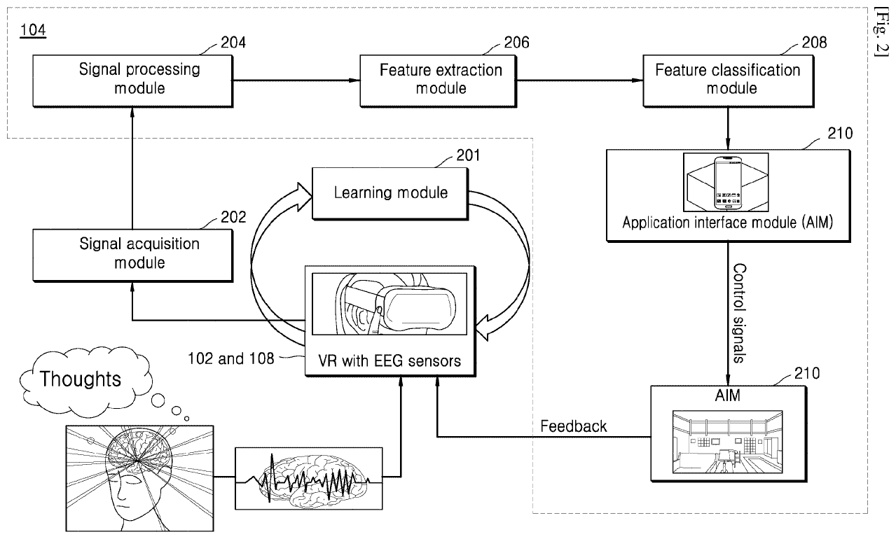

FIG. 2 illustrates block diagram of processing modules for determining defects in the visual field of the user, according to embodiments as disclosed herein. The HMD device 102 and electronic device 104 may include a plurality of processing modules. The HMD device 102 may include processing modules such as a learning module 201 and a signal acquisition module 202. Further, the electronic device 104 may include processing modules such as a signal processing module 204, a feature extraction module 206, a feature classification module 208, and an application interface module 210. In alternate embodiment, the HMD device 102 may also include a signal processing module 204, a feature extraction module 206, a feature classification module 208and an application interface module 210.

The HMD device 102 may be configured to learn the user behavior such as eye gaze, false positive, false negative and so on. Further, the EEG sensor device 108 may be coupled to the HMD device 102 to detect the signal from the brain of the user. The learned data may be transmitted to the signal acquisition module 202, wherein the signal acquisition module 202 may transmit the data to the signal processing module 204. The signal processing module 204may process the signal and transmit the process signal to feature extraction module 206. The feature extraction module 206 may extract the feature of the signal. The feature classification module 208 may classify the extracted feature, based on comparison with the stored table in the electronic device 104. The application interface module 210 may display the heat map or graph and provide the feedback corresponding to the user response, to the HMD device 102.

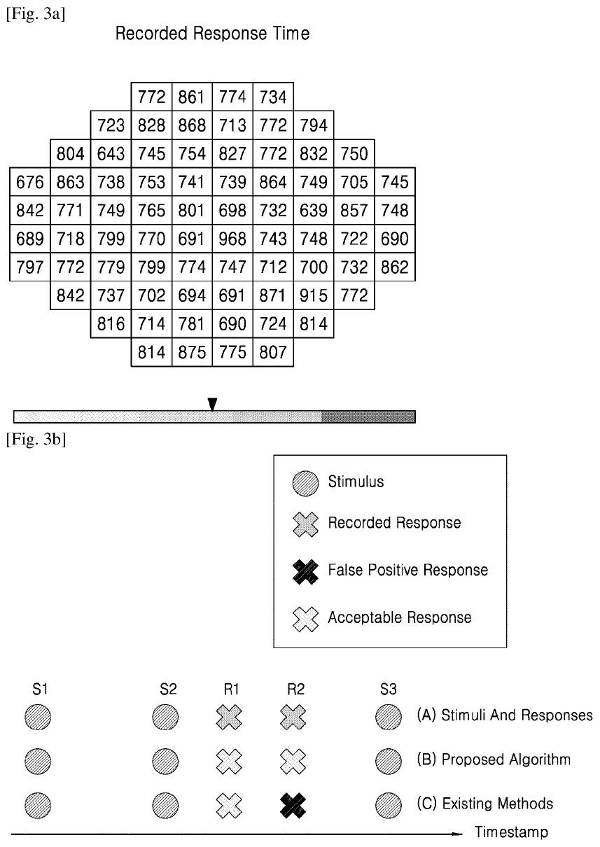

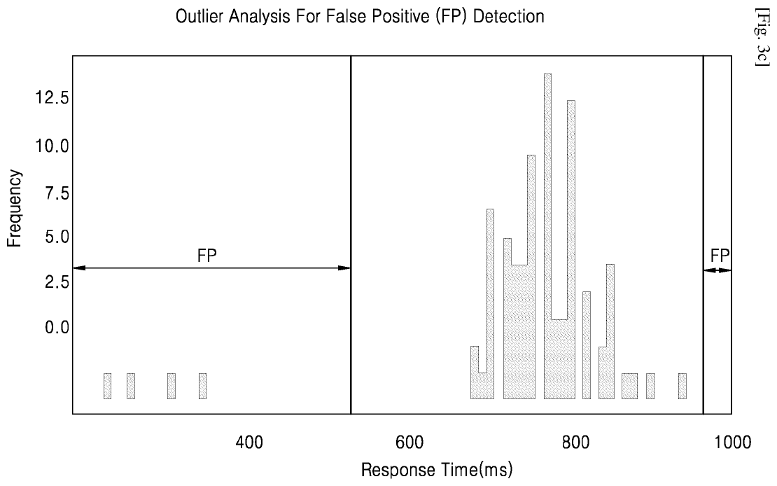

FIG. 3a illustrates a graphical representation of the recorded user response time via the input device 106, based on displayed visual stimuli on the HMD device 102, according to embodiments as disclosed herein.

For example, the user may choose to take supra-threshold or full threshold perimetry. Based on the selection of the type of test the visual stimuli may be displayed randomly to the user, on the display of HMD device 102. Each visual stimulus may be displayed for a pre-determined time interval (for example, 200 milliseconds) and the time interval between two stimuli ranges pre-determined time range (for example, 1100-2000 milliseconds). The time interval may ensure that the user may not register false responses by predicting the next displayed visual stimulus. The user may provide the response via the input device 106, if the user visualizes the visual stimuli each time. After the test, a report may be generated which displays the heat-map of visual field measurements based on the percentage of visual stimuli detected and the threshold sensitivity at each region of the display of the HMD device 102. Further, the time taken by the user to respond to the displayed visual stimuli may also be displayed on the at least one of HMD device 102 and the electronic device 104. The heat map may be displayed on at least one of the HMD device 102, the electronic device 104, and the input device 106. The reliability parameters such as false positives, false negatives and fixation loss may also be displayed along with the heat map.

FIG. 3b illustrates a schematic diagram of time stamp of user response time corresponding to the displayed visual stimuli, according to embodiments as disclosed herein.

For example, consider the situation as shown in FIG. 3b, where the response to a stimulus S1 is registered after displaying the next stimulus S2 (in the supra-threshold test). Based on False Positive (FP) detection method, the first response (R1) may be considered as the response to S2. Further, the response S1 maybe marked as undetected and the second response (R2) may also be considered a FP. However, it is to be understood that the user was able to detect both the displayed stimulus and further, there were no false positives. The situation can be solved by marking certain responses as an outliers based on the user response time distribution. The outliers can be solved by using a double median absolute deviation (DMAD) of the data. In an example, let RT be the vector of user response times and m=median (RT). Also, the left median absolute deviation (LMAD) can be calculated as follows:

lmad=k.median({|rt−m|^{u} rtεRT,rt≤m})

For a Gaussian distribution ‘k’=1.4826. Similarly, the ‘rmad’ may also be calculated. A response time less than ‘m’ is considered an outlier, if it lies more than ‘d’‘lmad's’ from ‘m’. A value greater than ‘m’ is considered an outlier if it lies more than ‘d’ ‘rmad's’ from ‘m’. The value of ‘d’ may be chosen to be 4.

FIG. 3c illustrates a graphical representation of outlier analysis for False Positive (FP) detection, according to embodiments as disclosed herein.

For example, the upper and lower bound obtained using the above explained procedure can be ub and lb. ‘T(Si)’ can be the timestamp of the ‘i’ th stimulus and ‘T(Ri)’ the timestamp of the ‘i’ th response. In the above mentioned situation shown in FIG. 3b, if,

T (R1)−T (S2)≤lb

Then, ‘R1’, is not treated as a valid response to ‘S2’. If additionally,

lb≤T (R1)−T (S1)≤ub,

Then, ‘R1’, is considered a valid response to ‘S1’. Similarly, ‘R2’ is considered a valid response to ‘S2’ if,

lb≤T (R2)−T (S2)≤ub

The FP rate higher than 15% may indicate an unreliable test result.

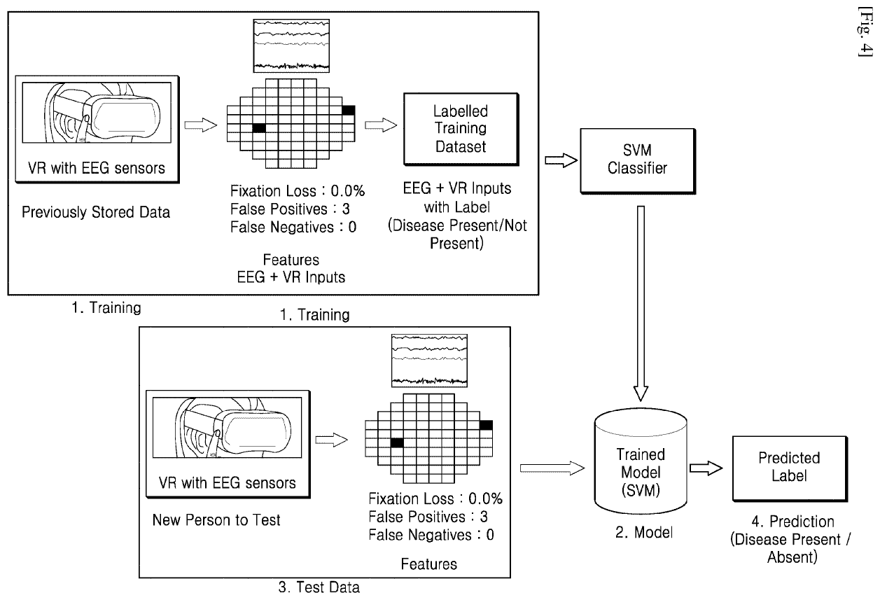

FIG. 4 illustrates a block diagram for learning the user behavior by using HMD device and EEG sensor device 108, according to embodiments as disclosed herein.

In an embodiment, a data is obtained from plurality of users via EEG sensor device 108. The obtained data is labeled based on the known neurological condition of respective user. The obtained data may include at least one of a data such as, but not limited to, a features extracted from data obtained by the EEG sensor device 108, a features received from the HMD device 102, a test data and an output value (such as determined brain disease). Further, a model may be trained using the labeled data, by using machine learning algorithm such as Support Vector Machine (SVM). Furthermore, the trained SVM model maybe used for predicting the neurological defects of user other than the previously tested users. The features extracted from the EEG sensor device 108 and the test data from the HMD device 102 corresponding to the new user can be an input to the model and the predicted value may be used to identify neurological defects of non-tested user.

The analyzed data may be stored in at least one of the electronic device 104 and the HMD device 102. The analyzed data may be stored along with the label if the eye disease is detected. The stored data may be sent to the Support Vector Machine (SVM) classifier module to classify the type of disease. The SVM module may learn the type of detected disease. Further, the eye test may be taken by another user and provide response to the visualized visual stimuli. The user response data may be stored and further sent to the trained SVM module. The trained SVM module may predict the type of visual disease of another user based on the learned data.

In an embodiment, an intensity threshold of each visual stimulus which may be seen by the user may be learned by the HMD device 102 based on machine learning algorithm. Further, the intensity may be varied by the HMD device 102 based on the learned threshold of each visual stimuli. The intensity may be increased or decreased in step size based on the real time learned data corresponding to the user response to each visual stimulus.

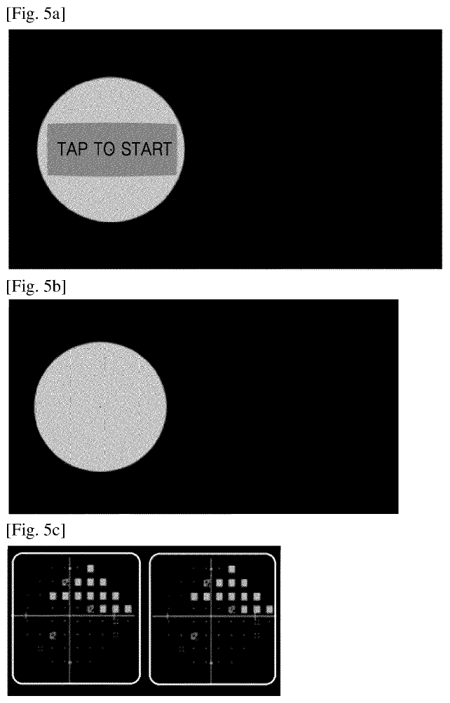

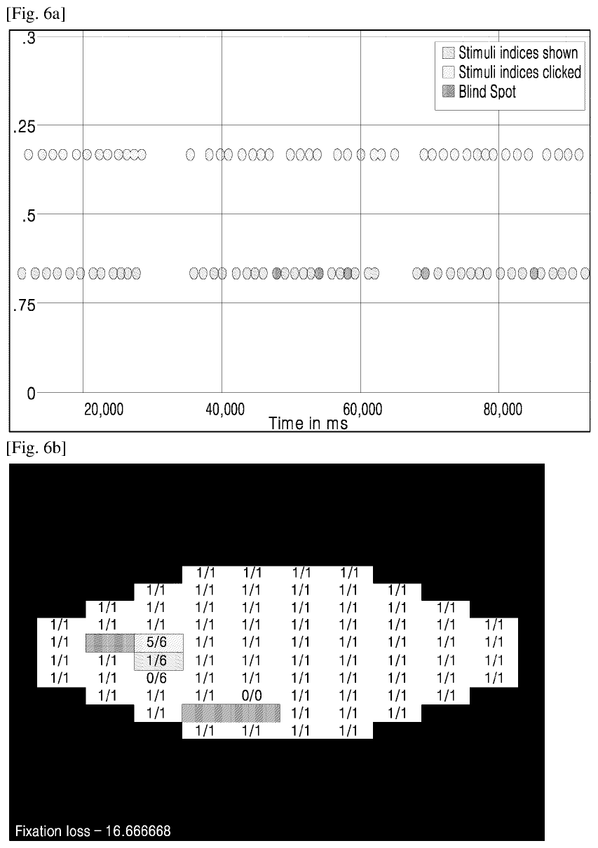

FIGS. 5a, 5b and 5c illustrate a schematic diagram of display of the HMD device 102, according to embodiments as disclosed herein. In an embodiment, the user may tap the input device 106 to begin the test. The visual stimuli may be displayed at random points and random times in the field of vision as directed by the physician. The user may indicate via the input device 106, when the displayed visual stimuli are visible to the user.

FIG. 6a illustrates a graph diagram for detected blind spot, according to embodiments as disclosed herein.

The user may be displayed with the visual stimuli on the display of the HMD device 102. The graph provides the data for the displayed visual stimuli and the response to the visualized stimuli indices provided by the user. The graph may also provide the data, if, no response is provided the user to the displayed visual stimuli. Based on the graphical data, the user may have knowledge of the defects in visual field of the user. The Supra-threshold strategy may provide a rapid quantitative measurement of the visual field. The visual stimuli of a pre-determined intensity which may be brighter than the expected threshold estimate displayed. However, the exact sensitivity may be not measured. In an example, the intensity of the stimuli may be varied from 0.5 at the center to 0.6 at the periphery of the eye.

I=0:5+0.1r²

Where, r is the distance from the center scaled to [0, 1] and ‘I’ is the brightness/luminance of visual stimulus in grayscale. The intensity of visual stimulus may be varied until ‘N’ time sat each region of the display of the HMD device 102. The varied intensity data may be stored in at least one of the electronic device 104 and the HMD device 102. The percentage of stimulus located at each region may be stored after the test. The additional visual stimuli may be displayed at the region of the display if the physiological blind spot is detected. The additional visual stimulus can be used to measure the fixation loss.

FIG. 6b, illustrates a heat map diagram for detecting reliability parameter such as fixation loss, according to embodiments as disclosed herein.

The reliability parameters can be measured to determine the exactness of the results of a test. In case of an unreliable test, an indication may be provided to the user to re-take the test. The standard Heijl-Krakau method and catch-trials method may be used to measure fixation loss and false negatives respectively. Further, if at least one of fixation loss and false negative is greater than 20% rate, then the test may be indicated as the unreliable test. The false positive may be estimated in the absence of the user responses based on the display visual stimulus. The Swedish Interactive Thresholding Algorithm (SITA) may be used for full threshold test. Also, the additional FP estimation method may be provided for the supra-threshold test based on the median absolute deviation of the user response time via the input device 106.

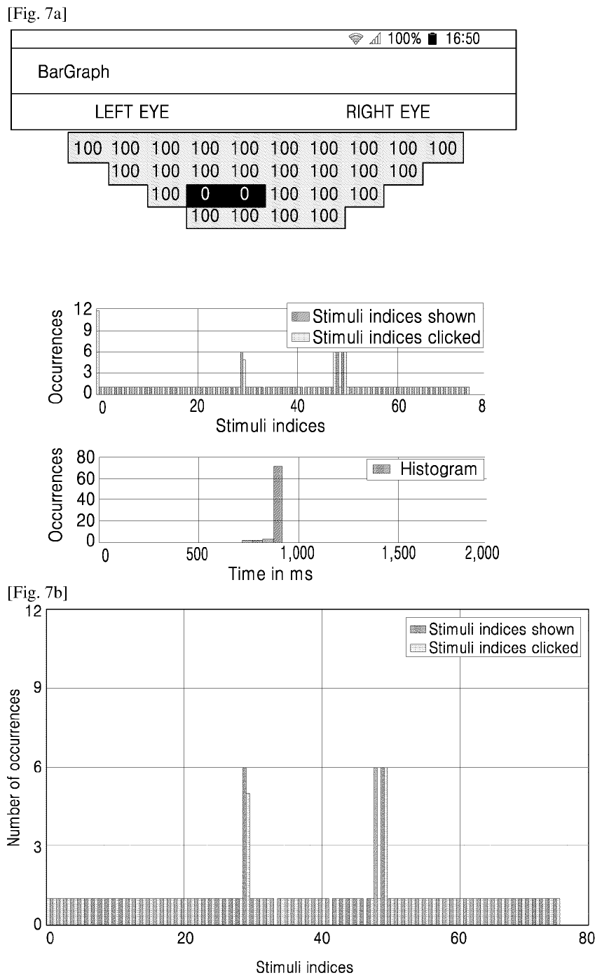

FIGS. 7a and 7b illustrates a graph diagram for response time provided by the user based on the visualized visual stimuli, according to embodiments as disclosed herein. The user response time may be recorded and acceptable upper and lower bounds may be calculated using the double median absolute deviation strategy. The graph provides the lower and upper bound of acceptable response times respectively.

FIG. 7c illustrates a heat map diagram for the response time provided by the user based on the visualized visual stimuli, according to embodiments as disclosed herein. The estimation of overall response time of the user corresponding to the each region of the displayed visual stimuli may be provided using heat map. The black spot shown in the FIG. 7c can be a blind spot of the user.

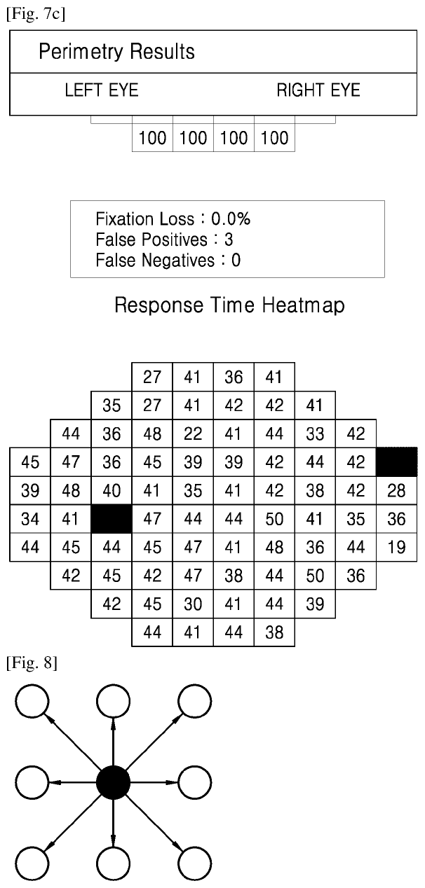

FIG. 8 illustrates a schematic diagram of a center weighted object displayed on the HMD device 102, according to embodiments as disclosed herein. The center weighted object may be moved to different region of the display of the HMD device 102, based on the detected eye gaze of the user.

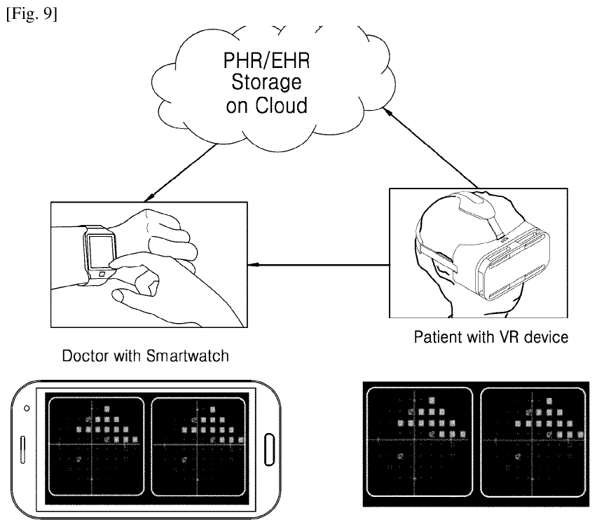

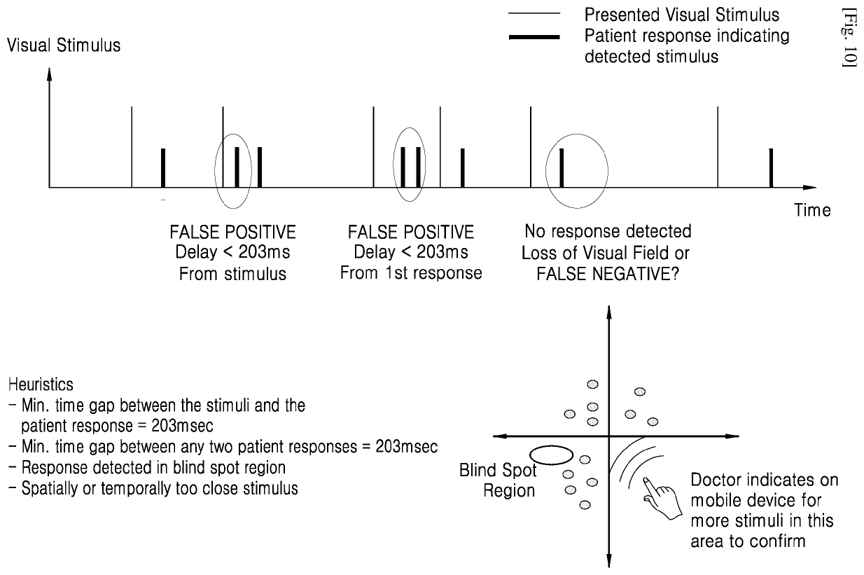

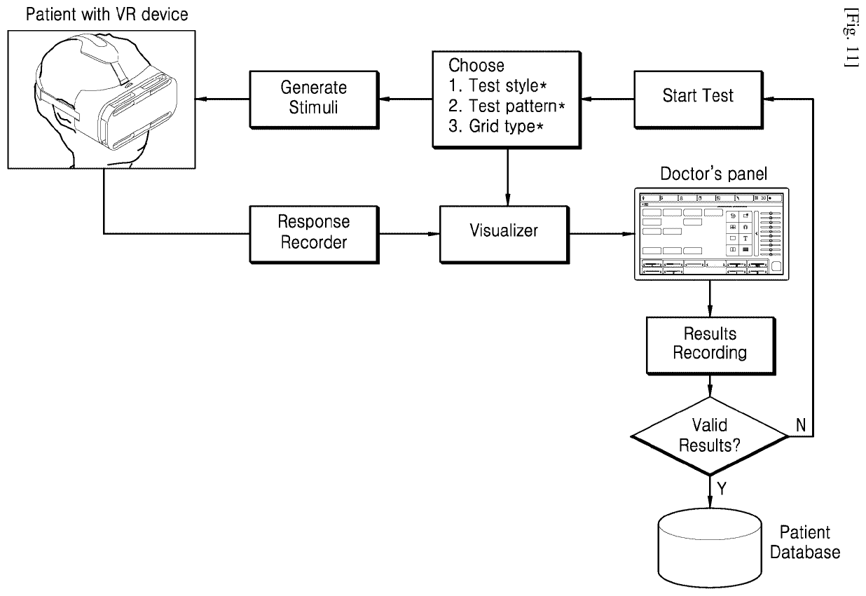

FIG. 9 illustrates a schematic diagram of a method for controlling the HMD device 102 by the physician, according to embodiments as disclosed herein. In an embodiment herein, the system 100 may also include server and cloud storage to interact between the devices of the system 100. The cloud storage may include an electronic health record (EHR) and personal health record (PHR) of the user. The physician may also be provided with the input device 106 and the electronic device 104 to control the HMD device 102 of the user. The PHR or EHR may be viewed by the physician to guide or control the HMD device 102 to detect the defects in visual field of the user.

FIG. 10 illustrates a graph diagram for indicating reliability parameters such as a false positive and a false negative data based on the response provided by the user, according to embodiments as disclosed herein.

The Heuristics method may be used to determine minimum time gap between the displayed visual stimuli and the user response. The time gap between the displayed visual stimuli and the user response can be greater than the pre-defined time period (for example, 203 milliseconds). The minimum time gap between any two user responses should be greater than the pre-defined time period (for example, 203 milliseconds).The response time of the user to the displayed visual stimuli is greater than the pre-defined time period then it can be considered as a false positive. Also, if the user response to the visual stimuli is greater than the pre-defined time period from the first provided response then it can be considered as a false positive. If the HMD device 102 detects no response, then it can be false negative or blind spot region of the user.

FIG. 11 illustrates a schematic diagram of overall system flow for determining the defects in the visual field of the user, according to embodiments as disclosed herein.

The HMD device 102 can perform supra-threshold perimetry and full threshold (30-2) perimetry test with Goldmann Size III visual stimulus. The HMD device 102 may test 76 points distributed over the central 30 degree field of view with 19 points in each quadrant. In alternate embodiment, another test protocol or stimulus size can be implemented by altering parameters. Throughout the test, the patient may be required to fixate on the center weighted object as marked by an indication (such as a black dot). Periodically, the user may be given an option to take rest for a desired amount of time, which in turn reduces physical discomfort such as eye strain and fatigue. The intensity may be measured in decibels (dB) as follows:

$$db = 10 {log}_{10} \frac{{L}_{max}}{{L}_{T} - {L}_{B}}$$

Where, ‘Lₘₐₓ’ is the maximum stimulus luminance, ‘L_{B}’ is the background luminance and ‘L_{T}’ is the visual stimulus luminance. The luminance can be measured in cd/m² whereas, brightness of display of electronic device 104 can be measured in grayscale value, wherein 0.0 corresponds to black and 1.0 corresponds to white.

Further, the intensity of visual stimuli in decibels is inversely proportional to the brightness of the visual stimulus. The ‘Lₘₐₓ’ can be 1.0 and ‘L_{B}’ can be 0:40. The threshold stimulus luminance may refer to the luminance of the stimulus, which has a 50% probability of being detected. The full threshold (4-2) stair-casing strategy with one reversal maybe implemented for threshold estimation. At, each region of the display of the HMD device 102 may have an expected sensitivity (14 dB); the visual stimulus intensity may be decreased by 4 dB till it is no longer detected by the user. Further, the intensity may be incremented in steps of 2 dB until the user sees it. Finally, it may be decreased by 2 dB until the user no longer visualizes it. The intensity of the last visual stimulus visualized by the user is recorded to be the threshold value. The process may be repeated for each test region. The regions in which the user may not detect visual stimulus can be compared to the blocked region of the lens for a measuring the accuracy. The average total testing time for both eyes can be 5.1 minutes including rest time. Accuracy(A) can be estimated as:

$$A = \frac{α + β}{N} \times 100$$

Where, ‘α’ is the number of stimulus detected in unblocked region, ‘β’ is the number of stimuli not detected in blocked region and N is the total number of stimuli presented. A mean accuracy of 98±1.2% may be obtained.

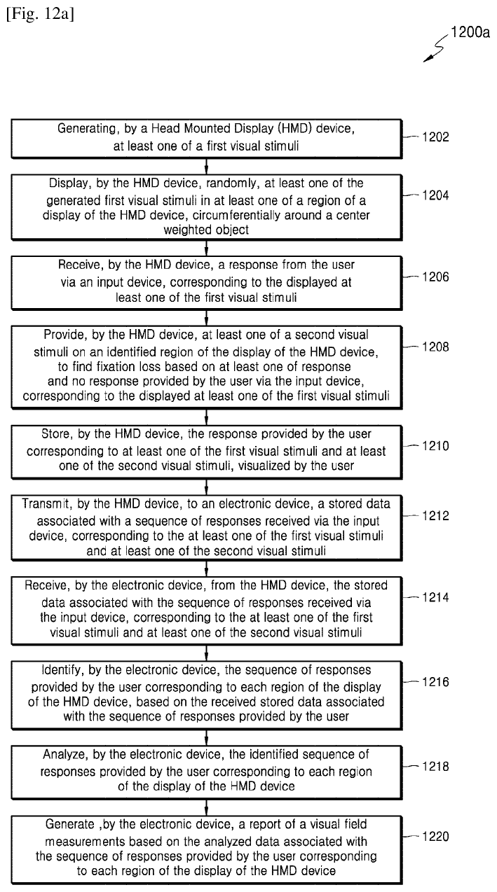

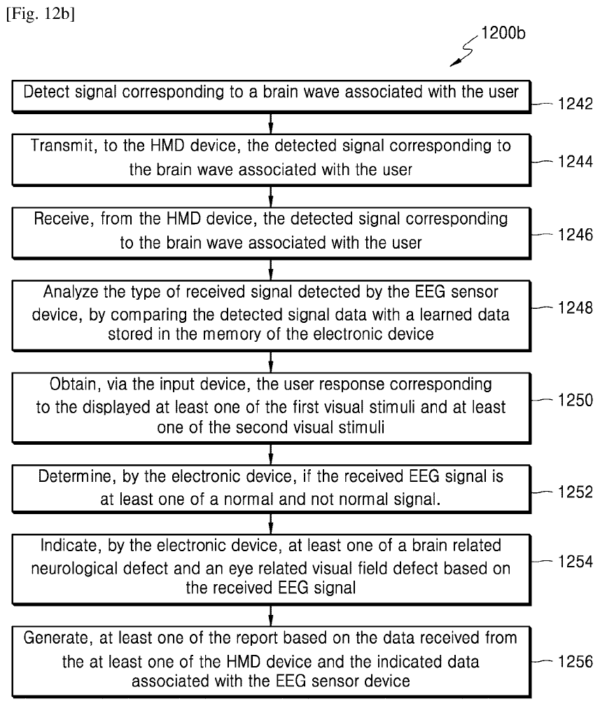

FIG. 12a is a flow chart of method 1200a for checking for at least one defect in visual field of the user, according to embodiments as disclosed herein.

At step 1202, at least one of a first visual stimuli is generated, by a Head Mounted Display(HMD) device 102. At step 1204, at least one of the generated first visual stimuli is randomly displayed by the HMD device 102 in at least one of a region of the display of the HMD device 102, circumferentially around a center weighted object, wherein the center weighted object is displayed on the display of the HMD device 102 for fixating an eye gaze of a user. At step 1206, a response from the user is received by the HMD device 102, via an input device 106, corresponding to the displayed at least one of the first visual stimuli. At step 1208, at least one of a second visual stimuli is provided by the HMD device 102, on an identified region of the display of the HMD device 102 to find fixation loss based on at least one of response and no response provided by the user via the input device 106, corresponding to the displayed at least one of the first visual stimuli, wherein the at least one of the second visual stimuli is displayed with at least one of an intensity value. At step 1210, the response provided by the user corresponding to at least one of the first visual stimuli and at least one of the second visual stimuli, visualized by the user, is stored by the HMD device 102. At step 1212, the stored data associated with a sequence of responses received via the input device 106 is transmitted by the HMD device 102, to an electronic device 104, corresponding to the at least one of the first visual stimuli and at least one of the second visual stimuli. At step 1214, the stored data associated with the sequence of responses received via the input device 106, corresponding to the at least one of the first visual stimuli and at least one of the second visual stimuli, is received by the electronic device 104, from the HMD device 102. At step 1216, the responses provided by the user corresponding to each region of the display of the HMD device 102 is identified by the electronic device 104, based on the received stored data associated with the sequence of responses provided by the user. At step 1218, the identified responses provided by the user corresponding to each region of the display of the HMD device 102 is analyzed by the electronic device 104. At step 1220, a report of a visual field measurements is generated by the electronic device 104, based on the analyzed data associated with the sequence of responses provided by the user corresponding to each region of the display of the HMD device 102, wherein the generated report comprises at least one of the responses and no responses provided by the user.

The various actions in method 1200a may be performed in the order presented, in a different order or simultaneously. Further, in some embodiments, some actions listed in FIG. 12a may be omitted.

FIG. 12b is a flow chart of method 1200b for checking for at least one defect in visual field of the user due to brain related visual field defect of the user by using EEG sensor device 108, according to embodiments as disclosed herein.

At step 1242, a signal corresponding to a brain wave associated with the user is detected by the EEG sensor device 108. At step 1244, the detected signal corresponding to the brain wave associated with the user is transmitted by the EEG sensor device 108 to the HMD device 102. At step 1246, the detected signal corresponding to the brain wave associated with the user is received by the electronic device 104 from the HMD device 102. At step 1248, the type of received signal detected by the EEG sensor device 108 is analyzed by the electronic device 104, by comparing the detected signal data with a learned data stored in the memory of the electronic device 104. At step 1250, the user response corresponding to the displayed at least one of the first visual stimuli and at least one of the second visual stimuli is obtained by the electronic device 104, via the input device 106. At step 1252, the received EEG signal is determined by the electronic device 104, if at least one of a normal and not normal signal. At step 1254, at least one of a brain related neurological defect and an eye related visual defect is indicated by the electronic device 104, based on the received EEG signal. At step 1256, at least one of the report is generated by the electronic device 104, based on the data received from the at least one of the HMD device 102 and the indicated data associated with the EEG sensor device 108.

The various actions in method 1200b may be performed in the order presented, in a different order or simultaneously. Further, in some embodiments, some actions listed in FIG. 12b may be omitted.

The embodiments disclosed herein can be implemented through at least one software program running on at least one hardware device and performing network management functions to control the elements. The elements shown in FIG. 1 can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

1. A method for checking for at least one defect in visual field of a user comprising:
generating, by a Head Mounted Display (HMD) device, at least one of a first visual stimuli;
displaying, by the HMD device, randomly, at least one of the generated first visual stimuli in at least one of a region of a display of the HMD device, circumferentially around a center weighted object, wherein the center weighted object is displayed on the display of the HMD device for fixating an eye gaze of a user;
receiving, by the HMD device, a response from the user via an input device, corresponding to the displayed at least one of the first visual stimuli;
providing, by the HMD device, at least one of a second visual stimuli on an identified region of the display of the HMD device to find fixation loss based on at least one of a response and a no response provided by the user via the input device, corresponding to the displayed at least one of the first visual stimuli, wherein the at least one of the second visual stimuli is displayed with at least one of an intensity value;
storing, by the HMD device, the response provided by the user corresponding to at least one of the first visual stimuli and at least one of the second visual stimuli, visualized by the user;
transmitting, by the HMD device, to an electronic device (104), a stored data associated with a sequence of responses received via the input device, corresponding to the at least one of the first visual stimuli and at least one of the second visual stimuli;
receiving, by the electronic device (104), from the HMD device, the stored data associated with the sequence of responses received via the input device, corresponding to the at least one of the first visual stimuli and at least one of the second visual stimuli;
identifying, by the electronic device, the sequences responses provided by the user corresponding to an each region of the display of the HMD device, based on the received stored data associated with the sequence of responses provided by the user;
analyzing, by the electronic device, the identified sequence of responses provided by the user corresponding to the each region of the display of the HMD device; and
generating, by the electronic device, a report of a visual field measurements based on the analyzed data associated with the sequence of responses provided by the user corresponding to each region of the display of the HMD device, wherein the generated report comprises at least one of the response and the no response provided by the user.

2. The method as claimed in claim 1, the method further comprising:
detecting, by an Electroencephalography (EEG) sensor device, a signal corresponding to a brain wave associated with the user;
transmitting, by the EEG sensor device, to the HMD device, the detected signal corresponding to the brain wave associated with the user;
receiving, by the electronic device, from the HMD device, the detected signal corresponding to the brain wave associated with the user;
analyzing, by the electronic device, the type of received signal detected by the EEG sensor device, by comparing the detected signal data with a learned data stored in the memory of the electronic device;
obtaining, by the electronic device, the user response via the input device, corresponding to the displayed at least one of the first visual stimuli and at least one of the second visual stimuli;
determining, by the electronic device, if the received EEG signal is at least one of a normal and a not normal signal;
indicating, by the electronic device, at least one of a brain related neurological defect and an eye related visual field defect based on the received EEG signal; and
generating, by the electronic device, at least one of the report based on the data received from the at least one of the HMD device and the indicated data associated with the EEG sensor device.

3. The method as claimed in claim 1, further comprises:
varying, by the HMD device,at least one of intensity value of at least one of the first visual stimuli and at least one of the second visual stimuli, based on the response received from the user via the input device, corresponding to the displayed at least one of the first visual stimuli in at least one of the region of the display of the HMD device, wherein the intensity of at least one of the first visual stimuli is varied by step size; and
learning, by the HMD device, a plurality of threshold values corresponding to the varied intensity of at least one of the first visual stimuli based on the response received from the user via the input device.

4. The method as claimed in claim 1, further comprises:
determining, by the HMD device, fixation of an eye gaze of the user on the center weighted object displayed on the display of the HMD device;
generating, by the HMD device, at least one of the first visual stimuli based on the determined fixation of the eye gaze of the user on the center weighted object displayed on the display of the HMD device;
identifying, by the HMD device, the eye gaze of the user on at least one of the center weighted object and the region of the display of the HMD device; and
modifying, by the HMD device, the position of the center weighted object with respect to the identified region of the display of the HMD device.

5. The method as claimed in claim 1, wherein the at least one of the first stimuli and at least one of the second stimuli comprises at least one of a spot, a letter, a symbol, a mathematical operator, a number and a geometrical shape.

6. The method as claimed in claim 1, wherein the at least one of the first stimuli and at least one of the second stimuli is displayed on one of the display of the HMD device, wherein the one of the display of the HMD device corresponds to at least one of a left eye and a right eye of the user.

7. The method as claimed in claim 1, wherein the type of test pattern preselected by the user comprises at least one of supra-threshold perimetry and full threshold perimetry.

8. The method as claimed in claim 1, wherein the generated report comprises at least one of a heat-map and a graph, wherein the at least one of the heat-map and the graph comprises data corresponding to at least one of a response time of the user, a false positive data, a false negative data and a fixation loss data.

9. The method as claimed in claim 8, wherein the false positive comprises analyzing time interval between the response of the user by using double mean absolute deviation method (DMAD), wherein the false positive comprises detecting response time of the user in different region of the display of the HMD device based on at least one of, time of the generation of at least one of the first visual stimuli and second visual stimuli, and the time of response provide by the user via input device.

10. A system for checking for at least one defect in visual field of a user comprising:
a head mounted display (HMD) device communicatively coupled to at least one of an electronic device and an input device, wherein the HMD device is configured to:
generate at least one of a first visual stimuli;
display, randomly, at least one of the generated first visual stimuli in at least one of a region of a display of the HMD device, circumferentially around a center weighted object, wherein the center weighted object is displayed on the display of the HMD device for fixating an eye gaze of a user;
receive, a response from the user via an input device, corresponding to the displayed at least one of the first visual stimuli;
provide at least one of a second visual stimuli on an identified region of the display of the HMD device to find fixation loss based on at least one of a response and a no response provided by the user via the input device, corresponding to the displayed at least one of the first visual stimuli, wherein the at least one of the second visual stimuli is displayed with at least one of an intensity value;
store the response provided by the user corresponding to at least one of the first visual stimuli and at least one of the second visual stimuli, visualized by the user;
to transmit to an electronic device, stored data associated with a sequence of responses received via the input device, corresponding to the at least one of the first visual stimuli and at least one of the second visual stimuli;
the input device communicatively coupled to the HMD device configured to:
receive response from the user corresponding to at least one of the first visual stimuli and at least one of the second visual stimuli, displayed on the display of the HMD device;
transmit the received response from the user corresponding to at least one of the first visual stimuli and at least one of the second visual stimuli, to the HMD device; and
the electronic device communicatively coupled to the HMD device configured to:
receive, from the HMD device, stored data associated with the sequence of responses received via the input device, corresponding to the at least one of the first visual stimuli and at least one of the second visual stimuli;
identify, the sequence of responses provided by the user corresponding to an each region of the display of the HMD device, based on the received stored data associated with the sequence of responses provided by the user;
analyze the identified sequence of responses provided by the user corresponding to the each region of the display of the HMD device; and generate, a report of a visual field measurements based on the analyzed data associated with the sequence of responses provided by the user corresponding to the each region of the display of the HMD device, wherein the generated report comprises at least one of the response and the no response provided by the user.

11. The system as claimed in claim 10, further comprising a Electroen-cephalography (EEG) sensor device communicatively coupled to the HMD device configured to:
detect signal corresponding to a brain wave associated with the user;
transmit, to the HMD device, the detected signal corresponding to the brain wave associated with the user; and
the electronic device communicatively coupled to the HMD device is further configured to:
receive, from the HMD device, the detected signal corresponding to the brain wave associated with the user;
analyze the type of received signal detected by the EEG sensor device, by comparing the detected signal data with learned data, stored in the memory of the electronic device;
obtain, the user response via the input device, corresponding to the displayed at least one of the first visual stimuli and at least one of the second visual stimuli;
determine, if the received EEG signal is at least one of a normal and a not normal signal;
indicate, at least one of a brain related neurological defect and an eye related visual defect based on the received EEG signal; and
generate at least one of the report based on the data received from the at least one of the HMD device and the indicated data associated with the EEG sensor device.

12. The system as claimed in claim 10, wherein the HMD device is further configured to:
vary an intensity of at least one of the first visual stimuli based on the response received from the user via the input device, corresponding to the displayed at least one of the first visual stimuli in at least one of the region of the display of the HMD device, wherein the intensity of at least one of the first visual stimuli is varied by step size; and learn, by the HMD device, a plurality of threshold values corresponding to the varied intensity of at least one of the first visual stimuli based on the response received from the user via the input device.

13. The system as claimed in claim 10, wherein the HMD device is further configured to:
determine, fixation of an eye gaze of the user on the center weighted object displayed on the display of the HMD device;
generate at least one of the first visual stimuli based on the determined fixation of the eye gaze of the user on the center weighted object displayed on the display of the HMD device;
identify the eye gaze of the user on at least one of the center weighted object and the region of the display of the HMD device; and
modify the position of the center weighted object with respect to the identified region of the display of the HMD device.

14. The system as claimed in claim 10, wherein the at least one of the first stimuli and at least one of the second stimuli comprises at least one of a spot, a letter, a symbol, a mathematical operator, a number and a geometrical shape.

15. The system as claimed in claim 10, wherein the at least one of the first stimuli and at least one of the second stimuli is displayed on one of the display of the HMD device, wherein the one of the display of the HMD device corresponds to at least one of a left eye and a right eye of the user.
